(19) United States
(12) Patent Application Publication
(10) Pub. No.: US 2014/0147205 A1
(43) Pub. Date: May 29, 2014

(54) BITUMINOUS COMPOSITION

(71) Applicants: David Strickland, Wythenshawe (GB); Majid Jamshed Chughtai, Ince (GB); Richard Walter May, Wichita, KS (US)

(72) Inventors: David Strickland, Wythenshawe (GB); Majid Jamshed Chughtai, Ince (GB); Richard Walter May, Wichita, KS (US)

(21) Appl. No.: 14/009,559

(22) PCT Filed: Apr. 5, 2012
(86) PCT No.: PCT/US2012/032324

§ 371 Date: Jan. 4, 2014

Related U.S. Application Data
(60) Provisional application No. 61/472,929, filed on Apr. 7, 2011.

(51) Int. Cl. C08L 95/00; E01C 21/00; C08K 3/06

(52) U.S. Cl. CPC C08L 95/00; C08K 3/06; E01C 21/00
USPC 404/75; 523/450; 523/400

(57) ABSTRACT

The invention provides a bituminous composition comprising 20 to 80 wt % bitumen, 0.1 to 7 wt % of a copolymer formed from monomers including ethylene and glycidyl methacrylate or glycidyl acrylate, and 20 to 60 wt % sulphur, all weight percentages based on the weight of the bituminous composition. It further provides a process for making this composition and asphalt compositions comprising such bituminous composition.

### FIELD OF THE INVENTION

The present invention relates to a bituminous composition that comprises bitumen, a polymer and sulphur. The invention also relates to a process for manufacturing the bituminous composition; sulphur pellets; an asphalt composition comprising the bituminous composition, a process for manufacturing the asphalt composition; a process for preparing an asphalt pavement; and the asphalt pavement thus prepared.

### BACKGROUND OF THE INVENTION

Bitumen is a material that is commonly used for the preparation of paving and roofing materials. In the road construction and road paving industry, it is a well-practised procedure to coat aggregate material such as sand, gravel, crushed stone or mixtures thereof with hot fluid bitumen, spread the coated material as a uniform layer on a road bed or previously built road while it is still hot, and compact the uniform layer by rolling with heavy rollers to form a smooth surfaced road.

The combination of bitumen with aggregate material, such as sand, gravel, crushed stone or mixtures thereof, is referred to as “asphalt”. Bitumen, also referred to as “asphalt binder”, is usually a liquid binder comprising asphaltenes, resins and oils. It may be naturally occurring, but may also be obtained from the residues of crude oils, e.g., by fractionation or by precipitation, e.g., by means of propane, or obtained after refining processes of crude oils, such as cracking. Bitumen usually contains hydrocarbons with a high asphaltene content, e.g., 12 wt % or more. The bitumen may also have undergone some further treatment, e.g. blowing, whereby bitumen components are subjected to oxidation with oxygen, e.g. air, or a chemical component, e.g. phosphoric acid.

It is known to modify the properties of bitumen by the addition of polymers. The addition of sulphur to polymer-modified bitumens comprising styrene-butadiene or styrene-butadiene-styrene is addressed in detail by Martinez-Estrada et al in the Journal of Applied Polymer Science, Vo. 115, 3409-3422 (2010). The addition of relatively small amounts of sulphur is shown to greatly increase the thermal stability of the modified bitumens. However, it is stated that precise dosing of sulphur is extremely important as slight excess leads to gel formation. The skilled person is aware that addition of small amounts of sulphur may be beneficial, but would be wary of adding larger amounts due to the risk of gellation.

WO 2007/002104 discloses polymer-modified bitumens comprising ethylene copolymers such as terpolymers of ethylene, n-butyl acrylate and glycidyl methacrylate. From about 0.001 to about 5 wt % of sulphur is included in the composition. Weight percentages are based upon the weight of the polymer-modified bitumen.

U.S. Pat. No. 6,011,094 discloses polymer-modified bitumens comprising elastomers such as styrene-butadiene copolymers and further comprising terpolymers of ethylene, ethyl acrylate and glycidyl methacrylate. The amount of sulphur is from 0.1 to 20% based upon the weight of the elastomer.

Bitumen compositions that contain sulphur and polymer have been described in WO-A 03/014231. To obtain improved paving binders sulphur is added to a bitumen binder and aggregate, sand or other materials. The sulphur acts as a so-called asphalt additive and is used to render the binder less flowable. The paving binder may comprise polymers or polymerisable materials as further constituents. Examples of polymerisable material or polymers are styrene monomer, polyethylene terephthalate, ethyl vinyl acetate, Exxon 101 or Exxon 103 and other vinyl aromatics.

The present inventors have sought to provide polymer-modified bitumen compositions that can be used to provide asphalt with advantageous properties or that can be used in improved processes for the production of asphalt.

### SUMMARY OF THE INVENTION

Accordingly, the present invention provides a bituminous composition comprising 20 to 80 wt % bitumen, 0.1 to 7 wt % of a copolymer formed from monomers including ethylene and glycidyl methacrylate or glycidyl acrylate, and 20 to 60 wt % sulphur, all weight percentages based on the weight of the bituminous composition.

It has been found that the properties of asphalt compositions can be further enhanced by the addition of sulphur and copolymer. The inventors have incorporated significant quantities of sulphur (from 20 wt %) into polymer-modified bitumen compositions, without experiencing the gellation that has been mentioned in the prior art. The copolymers used in the present invention (formed from monomers including ethylene and glycidyl methacrylate or glycidyl acrylate) appear to provide improved asphalt preparation processes wherein fuming is reduced.

The present invention also relates to a process for manufacturing the bituminous composition according to the present invention, the process comprising the steps of:
(i) heating bitumen;
(ii) mixing the hot bitumen so obtained with sulphur;
   wherein the copolymer is added in at least one of the steps (i) or (ii).

The bituminous composition according to the present invention can advantageously be applied in road and roofing applications, preferably road applications.

The present invention further relates to an asphalt composition comprising aggregate and the bituminous composition according to the present invention.

The present invention also provides a process for manufacturing the asphalt composition according to the present invention, the process comprising the steps of:
(i) heating bitumen;
(ii) heating aggregate;
(iii) mixing the hot bitumen with the hot aggregate in a mixing unit to form an asphalt composition;
   wherein sulphur is added in at least one of steps (i), (ii) or (iii); and wherein the copolymer is added in at least one of the steps (i), (ii) or (iii) or is pre-incorporated into the bitumen before step (i).

The present invention also provides a sulphur pellet comprising a copolymer formed from monomers including ethylene and glycidyl methacrylate or glycidyl acrylate. The sulphur pellet can be used in the processes for manufacturing the bituminous composition or the asphalt composition of the invention.

The present invention in addition also provides a process for preparing an asphalt pavement, wherein an asphalt composition is prepared by means of the present asphalt composition manufacturing process, followed by the steps of:
(iv) spreading the asphalt composition into a layer; and
(v) compacting the layer.

The present invention further relates to an asphalt pavement prepared by means of such a process.

### DETAILED DESCRIPTION OF THE INVENTION

The bituminous composition of the present invention comprises three essential components: bitumen, sulphur and copolymer.

The bitumen can be selected from a wide range of bituminous compounds. Whereas some documents in the prior art prescribe that the bitumen must have been subjected to blowing before it is to be used in paving applications, such requirement is not needed in the compositions according to the present invention. So, bitumen that can be employed may be straight run bitumen, thermally cracked residue or precipitation bitumen, e.g., from propane. Although not necessary, the bitumen may also have been subjected to blowing. The blowing may be carried out by treating the bitumen with an oxygen-containing gas, such as air, oxygen-enriched air, pure oxygen or any other gas that comprises molecular oxygen and an inert gas, such carbon dioxide or nitrogen. The blowing operation may be conducted at temperatures of 175 to 400° C., preferably from 200 to 350° C. Alternatively, the blowing treatment may be conducted by means of a catalytic process. Suitable catalysts in such processes include ferric chloride, phosphoric acid, phosphorus pentoxide, aluminium chloride and boric acid. The use of phosphoric acid is preferred.

The bitumen content in the bitumen composition according to the invention is from 20 to 80 wt %, based on the weight of the bituminous composition, more preferably from 30 to 75 wt %, most preferably from 50 to 75 wt %. Having less than 20 wt % bitumen can lead to asphalt compositions that are too stiff. Having more than 80 wt % bitumen can lead to asphalt compositions having poor mechanical properties, i.e. insufficient strength.

The copolymer used in the present invention is formed from monomers including ethylene and glycidyl methacrylate or glycidyl acrylate. In one embodiment the copolymer is formed only from ethylene and glycidyl methacrylate or is formed only from ethylene and glycidyl acrylate. In a preferred embodiment, the copolymer is formed from monomers including ethylene, alkyl acrylate and glycidyl methacrylate or glycidyl acrylate. Most preferably the copolymer is a terpolymer formed from ethylene, alkyl acrylate and glycidyl methacrylate or glycidyl acrylate. The amount of repeat units formed from alkyl acrylate is preferably from 1 to 70 wt %, based upon the weight of the terpolymer, more preferably from 5 to 45 wt %. The amount of repeat units formed from glycidyl methacrylate or glycidyl acrylate is preferably from 0.5 to 16 wt %, based upon the weight of the terpolymer, more preferably from 5 to 12 wt %. Suitable copolymers, sold under the Elvaloy trade mark, are available from DuPont.

The copolymer content in the bitumen composition according to the invention is from 0.1 to 7 wt %, based on the weight of the bituminous composition, more preferably from 0.1 to 5 wt %. Sufficient copolymer should be incorporated to achieve the required mechanical properties of the bitumen composition (and resulting asphalt), but the copolymer tends to be the most expensive component in the composition so it is desirable to limit the amount of copolymer. Indeed it has surprisingly been found that the copolymer is particularly effective in the present invention on account of the presence of sulphur. Therefore, the copolymer content in the bitumen composition may advantageously be at most 2 wt %, preferably at most 1 wt %, or even at most 0.7 wt % based on the weight of the composition.

Sulphur constitutes an essential part of the binder material and substantial amounts of sulphur are being used. That is different from the use of sulphur as cross-linking agent, where amounts usually below 2% wt, based on the weight of bitumen, sulphur and copolymer, are employed. In the application of the current invention the sulphur is present in amounts ranging from 20 to 60 wt %, based on the weight of the bitumen composition. The strength enhancement that is being provided to the bitumen composition by the sulphur is reduced when less than 20 wt % of sulphur is used in the bitumen compositions. Preferably, the sulphur is present in an amount ranging from 25 wt %, more preferably from 30 wt %. Preferably the sulphur is present in an amount up to 55 wt %. Most preferably the sulphur the sulphur is present in an amount of from 30 to 50 wt %. Having more than 55 wt % sulphur can lead to asphalt compositions that are too stiff.

As described in WO-A 03/014231 the sulphur may be added to the bitumen composition in the form of sulphur pellets, and preferably, the sulphur is incorporated into the compositions of the present invention in this form. Reference herein to pellets is to any type of sulphur material that has been cast from the molten state into some kind of regularly sized particle, for example flakes, slates or sphere-shaped sulphur such as prills, granules, nuggets and pastilles or half pea sized sulphur. The sulphur pellets typically comprise from 50 to 100 wt % of sulphur, based upon the weight of the sulphur pellets, preferably from 60 wt % and most preferably from 70 wt %; and typically to 99 wt %, and preferably to 95 wt % or to 100 wt %. A more preferred range is from 60 to 100 wt %.

These pellets may contain carbon black and, optionally, other ingredients, such as amyl acetate and wax. Carbon black may be present in amounts up to 5 wt %, based on the pellet, preferably up to 2 wt %. Suitably, the content of carbon black in the sulphur pellet is at least 0.25 wt %. The content of other ingredients, such as amyl acetate and wax, typically does not exceed an amount of 1.0 wt % each. When wax is present, it may be in the form of, for example, slack wax or wax derived from a Fischer-Tropsch process. Examples of suitable waxes for use herein are Sasobit®, a Fischer-Tropsch derived wax commercially available from Sasol, and SX100 wax, a Fischer-Tropsch wax from Shell Malaysia.

In one embodiment of the present invention, the copolymer is present in the sulphur pellet. The sulphur pellets preferably comprise from 0.1 to 28 wt % of the copolymer, based upon the weight of the sulphur pellet. The remainder of the pellet may be formed of sulphur, preferably in an amount of at least 50 wt % (more preferably 60 wt % or even 70 wt %) and optionally one or more other ingredients, e.g. as set out above.

The bituminous composition of the present invention may comprise polymers in addition to the copolymer formed from monomers including ethylene and glycidyl methacrylate or glycidyl acrylate. For example, the bituminous composition may comprise a copolymer formed from one or more vinyl aromatic compounds and one or more conjugated dienes, e.g. styrene butadiene rubber or styrene-butadiene-styrene block copolymer. However, in a preferred embodiment of the invention, the bituminous composition comprises 0.1 to 7 wt % polymer, based upon the weight of the bituminous composition, and at least 90 wt % of the polymer is the copolymer formed from monomers including ethylene and glycidyl methacrylate or glycidyl acrylate, based upon the weight of all polymer in the bituminous composition, more preferably at least 95 wt %. Most preferably, the copolymer formed from monomers including ethylene and glycidyl methacrylate or glycidyl acrylate is the only polymer in the bituminous composition.

The bituminous composition according to the present invention may also comprise an odour suppressant such as, for example, those disclosed in EP 2185640.

The bituminous and asphalt compositions of the present invention may also comprise wax, for example, slack wax or wax derived from a Fischer-Tropsch process. Examples of suitable waxes for use herein are Sasobit®, a Fischer-Tropsch derived wax commercially available from Sasol, and SX100 wax, a Fischer-Tropsch wax from Shell Malaysia.

The bituminous and asphalt compositions of the present invention may also comprise anti-stripping agents. Suitable antistrip additives include lime (e.g. hydrated lime, quick lime or dolomitic lime) or amines such as tallow diamine or bishexamethylenetriamine. The antistrip additive is suitably incorporated at between 0.1 and 3 wt %, more preferably approximately 1 wt %, based upon the weight of the bituminous composition.

The bituminous composition according to the invention is advantageously used in the form of an asphalt composition comprising the bituminous composition and filler and/or aggregate. Examples of fillers have been described in U.S. Pat. No. 5,863,971, and include carbon black, silica, calcium carbonate, stabilisers, antioxidants, pigments and solvents. Examples of aggregates include sand, rock, gravel, stones, pebbles etc. These aggregate materials are particularly useful for paving roads.

Typically, the asphalt composition comprises at least 1 wt % of bitumen, based on the weight of the asphalt composition. An asphalt composition comprising from about 1 wt % to about 10 wt % of bitumen is preferred, with a special preference for asphalt compositions comprising from about 3 wt % to about 7 wt % of bitumen, based on the weight of the asphalt composition. Thus, the asphalt composition may preferably comprise from about 90 wt % to about 99 wt % aggregate, more preferably from about 93 wt % to about 99 wt % aggregate.

The bituminous composition according to the present invention can be prepared by mixing the three essential ingredients in the appropriate amounts.

Accordingly, the present invention provides a process for manufacturing the bituminous composition according to the present invention, the process comprising the steps of:
(i) heating bitumen;
(ii) mixing the hot bitumen so obtained with sulphur;
   wherein the copolymer is added in at least one of the steps (i) or (ii) or is pre-incorporated into the bitumen before step (i). The present invention also provides a process for manufacturing the asphalt composition according to the present invention, the process comprising the steps of:
(i) heating bitumen;
(ii) heating aggregate;
(iii) mixing the hot bitumen with the hot aggregate in a mixing unit to form an asphalt composition;
   wherein sulphur is added in at least one of steps (i), (ii) or (iii); and wherein the copolymer is added in at least one of the steps (i), (ii) or (iii) or is pre-incorporated into the bitumen before step (i).

In step (i) of the processes for manufacturing the present bituminous or asphalt compositions the bitumen is heated, preferably at a temperature of from 60 to 200° C., preferably from 80 to 150° C., more preferably from 100 to 145° C., and even more preferably from 125 to 145° C. Working above 120° C. has the advantage that sulphur is liquid which facilitates the mixing process. Although the skilled person can easily determine the optimal mixing time the mixing time may be relatively short, e.g., from 10 to 600 seconds.

The bitumen is preferably a paving grade bitumen suitable for road application having a penetration of, for example, from 9 to 1000 dmm, more preferably of from 15 to 450 dmm (tested at 25° C. according to EN 1426: 2007) and a softening point of from 25 to 100° C., more preferably of from 25 to 60° C. (tested according to EN 1427: 2007).

In step (ii) of the process for manufacturing the present asphalt composition the aggregate is heated, preferably at a temperature of from 60 to 200° C., preferably from 80 to 170° C., more preferably from 100 to 160° C., even more preferably from 100 to 145° C. The aggregate is suitably any aggregate that is suitable for road applications. The aggregate may consist of a mixture of coarse aggregate (retained on a 4 mm sieve), fine aggregate (passes a 4 mm sieve but is retained on a 63 μm sieve) and filler (passes a 63 μm sieve).

In step (iii) of the asphalt manufacturing process, the hot bitumen and hot aggregate are mixed in a mixing unit. Suitably, the mixing takes place at a temperature of from 80 to 200° C., preferably from 90 to 150° C., more preferably from 100 to 145° C. Typically, the mixing time is from 10 to 60 seconds, preferably from 20 to 40 seconds.

The temperatures at which the bitumen and aggregate are heated and subsequently mixed are desirably kept as low as possible in order to reduce hydrogen sulphide emissions when the sulphur is added. However, the temperatures need to be sufficiently high such that the bitumen can effectively coat the aggregate. The present invention allows for bitumen, aggregate and sulphur mixes to be produced with suppression of odour emanating from the asphalt mixture.

In the process for manufacturing asphalt, sulphur is preferably added as late as possible in the process, preferably in step (iii).

In one embodiment of the present invention, sulphur is added in the form of sulphur pellets, as described above.

The sulphur and the copolymer may be added together, i.e. both in step (i), step (ii) or step (iii) of the respective processes for manufacturing the present bituminous and asphalt compositions. Alternatively, in the asphalt manufacture process the copolymer may be added separately. For example, the copolymer may be added to the bitumen in step (i) and the sulphur may be added in step (iii).

In a first preferred embodiment, hot bitumen is mixed with the copolymer, and then this is mixed with hot aggregate and with sulphur. In a second preferred embodiment, hot aggregate is mixed with hot bitumen, and the sulphur and the copolymer are added to the hot bitumen-aggregate mixture. This embodiment offers the advantage of producing a stronger sulphur-asphalt mixture strength.

In one embodiment of the invention, the sulphur and the copolymer are added together; the sulphur is in the form of pellets and the copolymer is incorporated in the sulphur pellets. The sulphur pellets preferably comprise from 0.1 to 28 wt % of the copolymer, based upon the weight of the sulphur pellet. The sulphur pellets are suitably prepared by a process wherein liquid sulphur is mixed with the copolymer and optionally additional components such as carbon black or amyl acetate. The mixture is then shaped and/or pelletised.

In one embodiment of the invention sulphur may be added in the form of two types of sulphur pellets; a first type of sulphur pellet that comprises the copolymer and a second type of sulphur pellet that does not comprise the copolymer. This has the advantage that the copolymer is essentially concentrated in the first type of sulphur pellet and conventional sulphur pellets can be used to make up the rest of the sulphur requirement.

In a preferred embodiment of the present invention, the copolymer is added in step (ii) of the process for manufacturing asphalt compositions. In a particularly preferred embodiment, copolymer in the form of a liquid dispersion, is sprayed onto the hot aggregate to produce polymer-coated aggregate, then the polymer-coated aggregate is mixed with hot bitumen, followed by addition of sulphur, preferably in the form of pellets.

The invention further provides a process for preparing an asphalt pavement, wherein asphalt is prepared by a process according to the invention, and further comprising steps of:
(iv) spreading the asphalt into a layer; and
(v) compacting the layer.

The invention further provides an asphalt pavement prepared by the processes according to the invention.

The compaction in step (v) suitably takes place at a temperature of from 80 to 200° C., preferably from 90 to 150° C., more preferably from 100 to 145° C. The temperature of compaction is desirably kept as low as possible in order to reduce hydrogen sulphide emissions. However, the temperature of compaction needs to be sufficiently high such that the voids content of the resulting asphalt is sufficiently low for the asphalt to be durable and water resistant.

The invention will now be illustrated by means of the following two sets of Examples, which are not intended to limit the invention.

### Preparation of Asphalt Compositions—Set 1

A first set of asphalt compositions was prepared using a diabase aggregate from northern Virginia. Table 1 shows the aggregate gradation for making mixes in this study:

| Sieve size (mm) | % passing |
|---|---|
| 19.0 | 100.0 |
| 12.5 | 93.3 |
| 9.5 | 84.1 |
| 4.75 | 57.5 |
| 2.36 | 35.9 |
| 1.18 | 24.4 |
| 0.600 | 17.2 |
| 0.300 | 12.2 |
| 0.150 | 8.5 |
| 0.075 | 6.0 |

The bitumen used in both compositions was a PG 64-22 grade bitumen from NuStar. The continuous grade of the bitumen used in Comparative Example 1 was PG 69.9-22.1, whereas the continuous grade of the bitumen used in Example 1 was PG 65.4-25.82.

A hot mix asphalt comprising no sulphur and no polymer was prepared according to standard methods (based on a Superpave mix design in accordance with at AASHTO T312) as a control (Comparative Example 1). The hot mix asphalt was prepared by mixing 94.7 wt % of the diabase aggregate with 5.3 wt % of paving grade bitumen (PG 64-22) at 150° C. This was compacted using a Superpave gyratory compactor at 140° C. with a target air void content of 7.0±0.5% to give test specimens.

A warm mix asphalt comprising sulphur and polymer was prepared based on a Superpave mix design (in accordance with at AASHTO T312) according to the invention (Example 1). The warm mix asphalt was prepared by mixing 92.9 wt % of the diabase aggregate and 1.0 wt % hydrated lime with 4.2 wt % of bituminous component followed by 1.9 wt % Shell Thiopave (RTM) pellets (consisting of about 98-99.5 wt % elemental sulphur and balance carbon black) at 135° C. The bituminous component was composed of 99.5 wt % paving grade bitumen (PG 64-22) and 0.5 wt % Elvaloy AM from DuPont (an ethylene/n-butyl acrylate/glycidyl methacrylate terpolymer). In this example, the Elvaloy AM polymer was thus incorporated into the bituminous composition before sulphur. The mixture was compacted in a Superpave gyratory compactor at 115° C. with a target air void content of 7.0±0.5% to give test specimens. The test specimens were placed in an oven set at 60° C. and cured for 24 hours to give samples suitable for performance testing.

### Performance Tests and Comparison—Set 1

Rutting resistance of the asphalt of Comparative Example 1 and Example 1 was measured using the Hamburg Wheel Tracking Test (AASHTO T 324), the AMPT Flow Number Test (AASHTO TP 62) and measurements of Dynamic Modulus (AASHTO TP 62). The results are shown in Table 2:

| | | Comparative Example | Example |
|---|---|---|---|
| | | 1 | 1 |
| Hamburg Rut Depth at | | 5.6 | 2.4 |
| 50° C. (mm) | | | |
| Flow Number at 52° C. | | 95 | 190 |
| Dynamic Modulus | 4° C. | 13224 | 16508 |
| (MPa) | 20° C. | 4635 | 6330 |
| | 40° C. | 690 | 1048 |

The wheel tracking and flow number results for the asphalt based on the bituminous composition of the invention (Example 1) were considerably better than for Comparative Example 1 (hot mix asphalt comprising no sulphur or polymer) indicating improved rutting resistance. The dynamic modulus results for the asphalt based on the bituminous composition of the invention (Example 1) were higher than for Comparative Example 1 (hot mix asphalt comprising no sulphur or polymer) particularly at the higher temperatures showing the synergistic effects of sulphur and polymer.

### Preparation of Asphalt Compositions—Set 2

A second set of asphalt compositions was prepared using a Superpave mix design with a 25 mm nominal aggregate size. The bitumen used in both compositions was a paving grade bitumen (PG 64-22).

A warm mix asphalt comprising sulphur but no polymer was prepared as a control (Comparative Example 2). At a continuous counterflow drum mix plant an asphalt composition of 95.4 wt % aggregate was mixed with 3.2 wt % bituminous component and 1.4 wt % elemental sulphur pellets (GX rotoform pellets) at 130±5° C. The bituminous component contained 1.0 wt % Sarawax SX100 (based on the weight of bitumen). Samples of this asphalt were taken to the laboratory for evaluation.

A warm mix asphalt according to the invention (Example 2) was produced in a similar manner to Comparative Example 2 with the exception that the bituminous component contained 0.5 wt % (by weight of bitumen) of Elvaloy AM from DuPont an ethylene/n-butyl acrylate/glycidyl methacrylate terpolymer). In this example, the Elvaloy AM polymer was thus also incorporated into the bituminous composition before sulphur.

The mixtures of Comparative Example 2 and Example 2 were re-heated to 130±5° C. in a laboratory and compacted using a Superpave gyratory compactor to provide cylindrical specimens for evaluation. The specimens were stored at ambient temperature for 14 days prior to testing.

### Performance Tests and Comparison—Set 2

Rutting resistance of the asphalt of Comparative Example 2 and Example 2 was measured using the Hamburg Wheel Tracking Test (AASHTO T 324), the AMPT Flow Number Test (AASHTO TP 62) and measurements of Dynamic Modulus (AASHTO TP 62). The results are shown in Table 3:

| | | Comparative Example | Example |
|---|---|---|---|
| | | 2 | 2 |
| Hamburg Rut Depth at | | 13 | 4 |
| 50° C. (mm) | | | |
| Flow Number at 52° C. | | 963 | 3887 |
| Dynamic Modulus | 4° C. | 20395 | 18864 |
| (MPa) | 20° C. | 11477 | 11299 |
| | 40° C. | 3630 | 4010 |

The wheel tracking and flow number results for the bituminous composition of the invention (Example 2) were considerably better than for Comparative Example 2 (without polymer) indicating improved rutting resistance. The dynamic modulus results for the asphalt composition of the invention (Example 2) and Comparative Example 2 were of comparable values at 4° C. and 20° C. However, at 40° C. the dynamic modulus of Example 2 was higher than for Comparative Example 2 (without polymer) at 40° C. indicating the improved strength due to the polymer.

1. A bituminous composition comprising 20 to 80 wt % bitumen, 0.1 to 7 wt % of a copolymer formed from monomers including ethylene and glycidyl methacrylate or glycidyl acrylate, and 20 to 60 wt % sulphur, all weight percentages based on the weight of the bituminous composition.

2. A bituminous composition according to claim 1, wherein the copolymer is formed from monomers including ethylene, alkyl acrylate and glycidyl methacrylate or glycidyl acrylate.

3. A bituminous composition according to claim 2, wherein the copolymer is a terpolymer formed from ethylene, alkyl acrylate and glycidyl methacrylate or glycidyl acrylate.

4. A bituminous composition according to claim 3, comprising 0.1 to 7 wt % polymer, based upon the weight of the bituminous composition, wherein at least 90 wt % of the polymer is the copolymer formed from monomers including ethylene and glycidyl methacrylate or glycidyl acrylate, based upon the weight of all polymer in the bituminous composition.

5. A process for manufacturing a bituminous composition, the process comprising the steps of:
(i) heating bitumen;
(ii) mixing the hot bitumen so obtained with sulphur,
wherein a copolymer formed from monomers including ethylene and glycidyl methacrylate or glycidyl acrylate is added in at least one of the steps (i) or (ii).

6. An asphalt composition comprising aggregate and a bituminous composition according to claim 1.

7. An asphalt composition according to claim 6 comprising in the range of from 1% to 10% by weight of the bituminous composition.

8. An asphalt composition according to claim 7 comprising in the range of from 90 to 99% by weight of aggregate.

9. A process for manufacturing the asphalt composition, the process comprising the steps of:
(i) heating bitumen;
(ii) heating aggregate;
(iii) mixing the hot bitumen with the hot aggregate in a mixing unit to form an asphalt composition;
wherein sulphur is added in at least one of steps (i), (ii) or (iii); and wherein a copolymer formed from monomers including ethylene and glycidyl methacrylate or glycidyl acrylate is added in at least one of the steps (i), (ii) or (iii) or is pre-incorporated into the bitumen before step (i).

10. A process according to claim 9, wherein the sulphur is added at step (iii), after the copolymer is added or pre-incorporated.

11. A process for preparing an asphalt pavement, wherein an asphalt composition is prepared by a process according to claim 9, followed by the steps of:
(iv) spreading the asphalt composition into a layer; and
(v) compacting the layer.

12. A sulphur pellet comprising a copolymer formed from monomers including ethylene and glycidyl methacrylate or glycidyl acrylate and sulphur.

13. The sulphur pellet of claim 12 comprising in the range of from 0.1 to 28 wt % of the copolymer and at least 50 wt % sulphur.
